(19) United States
(12) Patent Application Publication
(10) Pub. No.: US 2011/0058757 A1
(43) Pub. Date: Mar. 10, 2011

(54) BEARING BUSH, IN PARTICULAR FOR A SHIFT HOUSING OF A VEHICLE, AND METHOD FOR INSTALLING THE BEARING BUSH

(75) Inventors: Sascha BRUDER, Mainz (DE); Thorsten HAHN, Gau-Odernheim (DE)

(73) Assignee: GM GLOBAL TECHNOLOGY OPERATIONS, INC., Detroit, MI (US)

(21) Appl. No.: 12/872,598

(22) Filed: Aug. 31, 2010

(30) Foreign Application Priority Data
Aug. 31, 2009 (DE) 102009037068.4

(51) Int. Cl. F16C 33/00; B21D 53/10

(52) U.S. Cl. 384/42; 29/898

(57) ABSTRACT

A bearing bush is provided for a shift housing of a vehicle, and a method is provided for installing the bearing bush. The bearing bush is used for mounting a selection lever in a shift housing of a vehicle, the selection lever transmitting selection movements of a selection finger of a gear shift lever to traction and/or compression movements of a selection cable pull. The selection lever pivots around its pivot point into various selection positions and is mounted so it is rotatable on a cast-on bearing journal of the shift housing the bearing bush. The bearing bush has radial and axial compensation elements, which axially lock the selection lever on the bearing journal during pivot movements.

### CROSS-REFERENCE TO RELATED APPLICATION

This application claims priority to German Patent Application No. 102009037068.4, filed Aug. 31, 2009, which is incorporated herein by reference in its entirety.

### TECHNICAL FIELD

The invention relates to a bearing bush, in particular for a shift housing of a vehicle, and a method for installing the bearing bush. The bearing bush is used for mounting a selection lever in a shift housing of a vehicle, the selection lever transmitting selection movements of a selection finger of a gear shift lever to traction and/or compression movements of a selection cable pull. The selection lever pivots into various selection positions around a pivot point.

### BACKGROUND

Bearing bushes are typically inserted into friction bearings, bearing bushes of this type reducing the sliding friction of a friction bearing. FIG. 4 shows a typical mounting of a selection lever 2 in a shift housing 3, the mounting of the selection lever, which is capable of rotating around a pivot point 4, in order to transmit various positions of a selection finger of a gear shift lever with the aid of a receptacle hole 19 for the selection finger to an attachment pin 20, being mechanically connected to the selection cable pull.

In order to ensure pivoting of the selection lever 2 around the pivot point 4, the selection lever 2 is fixedly connected to a selection shaft 21, which is in turn mounted in two friction bearings 24 and 25 of the shift housing 3. To axially secure the selection shaft 21 in the friction bearings 24 and 25, additional securing elements are required, such as a clip ring, which is clipped onto a ring groove 9 of the selection shaft 21 after positioning of the selection shaft 21 shown in FIG. 4 in the friction bearings 24 and 25.

The requirement according to the prior art of mounting a selection shaft in two friction bearings 24 and 25 on the shift housing 3 is connected to relatively complex installation. In addition, it is disadvantageous that the production method of two exactly aligned friction bearings for the selection shaft requires costly post-processing after injection molding of the shift housing, in order to achieve secure mounting of the selection lever 2 around its pivot point 4.

At least one object of the invention is to disclose a bearing bush which, in cooperation with improved shift housing, allows rapid, secure, and cost-effective installation of a selection lever, which is pivotable around its pivot point, and ensures its axial locking. In addition, other objects, desirable features, and characteristics will become apparent from the subsequent summary and detailed description, and the appended claims, taken in conjunction with the accompanying drawings and this background.

### SUMMARY

According to an embodiment of the invention, a bearing bush, in particular for a shift housing of a vehicle and a method for installing the bearing bush are provided. The bearing bush is used for mounting a selection lever in a shift housing of a vehicle, the selection lever transmitting selection movements of a selection finger of a gear shift lever to traction and/or compression movements of a selection cable pull. The selection lever pivots around a pivot point into various selection positions and is mounted so it is rotatable on a cast-on bearing journal of the shift housing the bearing bush. The bearing bush has radial and axial compensation elements which axially lock the selection lever on the bearing journal in the event of pivot movements.

A bearing bush of this type has the advantage that the compensation elements allow simple and cost-effective installation of the selection lever on the cast-on bearing journal of the shift housing and simultaneously ensure axial securing of the selection lever on the bearing journal without additional securing elements. Furthermore, the bearing bush allows a double-mounted selection shaft for the selection lever to be dispensed with, which in turn reduces the costs for the production of the shift housing.

For this purpose, the bearing journal is preferably fixed using a cast-on end on an axial contact surface of the shift housing. On its free end, the bearing journal has a ring groove, in which compensation elements in the form of internal snap hooks of the bearing bush engage. This has the advantage that when the bearing bush is put onto the bearing journal, the internal snap hooks of the bearing bush catch automatically in the ring groove on the free end of the bearing journal.

Furthermore, it is provided that the selection lever has a bearing hole, for the pivotable mounting on the bearing journal, in the pivot point. The bearing hole has an indentation of a larger diameter than the bearing hole, the compensation elements in the form of external snap hooks of the bearing bush being engaged with the indentation. This has the advantage that the selection lever is axially locked in its position in the bearing hole by the compensation elements of the bearing bush.

In addition, it is provided that the bearing bush has a flange-like shoulder, which is supported on the axial contact surface of the shift housing and has axially acting compensation elements in the form of spring elements, which axially lock the shoulder in relation to the external snap hooks on the indentation of the bearing hole of the shift lever. These spring elements of the flange-like collar press against a tubular extension of the bearing opening of the shift lever on one side and thus axially fix the external snap hooks, which are supported on the indentation in the bearing hole.

In addition, further compensation elements in the form of axially acting spring elements are provided on the flange-like shoulder, which axially lock the shoulder in relation to the internal snap hooks of the ring groove of the bearing journal. It is thus ensured that the selection lever is axially secured in both directions by the compensation elements, which are provided in the form of external and internal snap hooks and in the form of axially acting spring elements on the one-piece bearing bush.

By inserting a bearing bush between the selection lever and the shift housing, it is possible to produce both the selection lever and also the shift housing from an identical materials such as fiber-reinforced polyamide in the injection-molding method and to protect it from friction wear through the interposed bearing bush, in that the bearing bush is produced from another low-friction plastic such as polytetrafluoroethylene.

In order to ensure that the cast-on bearing journal on the contact surface of the shift housing can transmit the forces which act on the selection lever to the shift housing, it is provided that the shift housing has a reinforcement element in the area of the cast-on bearing journal. This reinforcement element can also be produced during the injection molding of the shift housing.

As in the prior art, a spring element can also be provided on the shift housing here, which is supported on the shift housing and holds the selection lever and, via the selection finger, thus the gear shift lever in a neutral selection position, from which the various selection settings may be set by a gear shift lever against the restoring force of this spring element.

A method for installing the bearing bush in a shift housing has the following method steps. Firstly, a shift housing having a cast-on bearing journal for the pivotable mounting of a selection lever on the shift housing is produced. The bearing journal has a ring groove for axially securing the selection lever. In addition, a bearing bush is produced, which can be fitted in a bearing hole of the selection lever. The bearing bush is then fitted in the bearing hole of the selection lever while external snap hooks of the bearing bush snap into an indentation of the bearing hole of the selection lever. Subsequently, the selection lever having bearing bush is put onto the cast-on bearing journal of the shift housing while internal snap hooks of the bearing bush snap into the ring groove of the bearing journal and with a selection finger of a gear shift lever simultaneously being received in a receptacle hole of the selection lever spaced apart from the pivot point.

This installation has the advantage that it can be performed cost-effectively by simply fitting and plugging the selection lever onto the bearing journal with the aid of the bearing bush and no additional securing elements are to be attached to the bearing journal and/or the selection lever. In addition, the method dispenses completely with the provision of a selection shaft and with the provision of two friction bearings for a selection shaft of this type on the shift housing. Spring elements of a flange-like shoulder of the bearing bush hold the selection lever on the bearing journal in an axially locked position, the selection lever itself remaining pivotable around this position or its pivot point on the bearing journal.

After installation of the selection lever and the simultaneous insertion of the selection finger into the receptacle hole of the selection lever, a selection cable pull can be connected to an attachment journal of the selection lever. This attachment journal is a ball stud, on which a corresponding ball capsule of the selection cable pull is placed. Furthermore, it is provided that the shift housing is reinforced in the area of the cast-on bearing journal, a double friction bearing guide of the selection shaft becoming superfluous through this reinforcement and thus the production costs being able to be reduced.

### BRIEF DESCRIPTION OF THE DRAWINGS

The present invention will hereinafter be described in conjunction with the following drawing figures, wherein like numerals denote like elements, and.

FIG. 1 shows a schematic perspective view of a bearing bush according to an embodiment of the invention;

FIG. 2 shows a schematic exploded perspective view of a shift housing having the bearing bush according to FIG. 1 for mounting a selection lever on a bearing journal of the shift housing;

FIG. 3 shows a schematic exploded perspective view of a bearing bush of a shift housing according to FIG. 2 from a different perspective; and

FIG. 4 shows a schematic exploded perspective view of a shift housing having a selection lever and a selection shaft according to the prior art.

### DETAILED DESCRIPTION

The following detailed description is merely exemplary in nature and is not intended to limit application and uses. Furthermore, there is no intention to be bound by any theory presented in the preceding background or summary or the following detailed description.

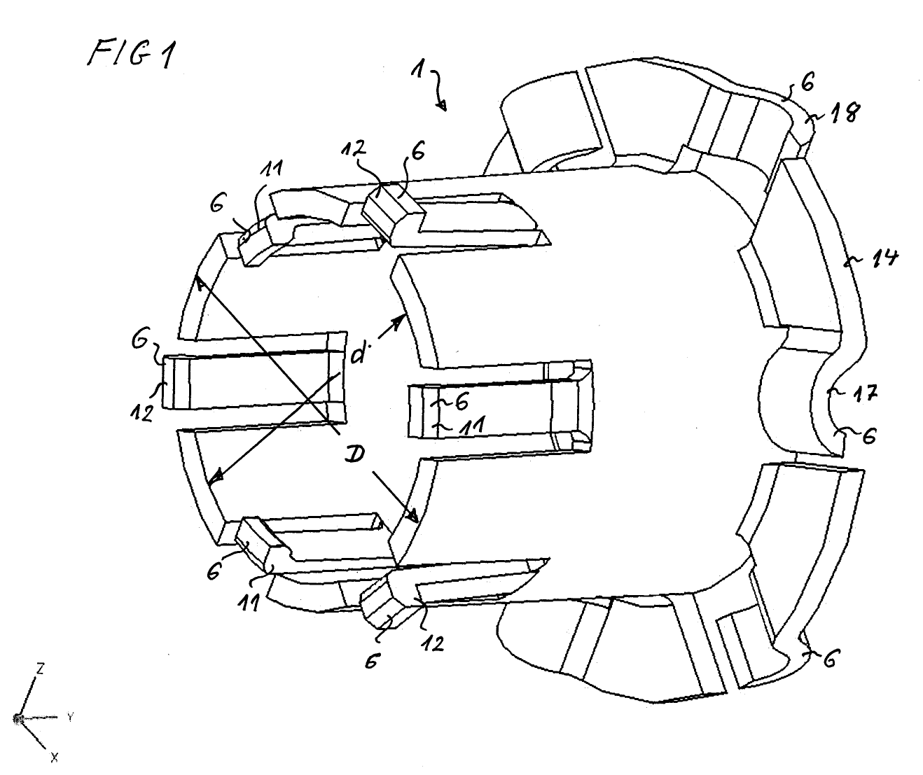

FIG. 1 shows a schematic perspective view of a bearing bush 1 according to an embodiment of the invention. The bearing bush 1 is adapted using its internal diameter d to the external diameter of a bearing journal cast onto a shift housing. In addition, the bearing bush 1 is adapted using its external diameter D to the internal diameter of a bearing hole of a selection lever situated so it is rotatable on bearing bush 1. Three external snap hooks 12 distributed around the circumference protrude beyond the external diameter D of the bearing bush 1 in this embodiment of the bearing bush 1, which can be engaged with a corresponding indentation of the bearing hole of the selection lever. Furthermore, three internal snap hooks 11 distributed around the circumference of the bearing bush protrude into the internal diameter d in this embodiment of the invention, which can be engaged in a ring groove on the free end of the bearing journal 5 cast onto the shift housing.

In addition to the compensation elements 6 in the form of internal snap hooks 11 and external snap hooks 12 distributed around the circumference of the bearing bush 1, further axial compensation elements 6 are situated on a flange-like shoulder 14 of the bearing bush 1 in the form of spring elements 17 and 18. Three spring elements 17 distributed uniformly on the flange-like shoulder 14 cooperate with the external snap hooks 12 and axially lock the selection lever on the bearing bush 1. Three further spring elements 18 are supported on a contact surface of the shift housing, and cooperate with the internal snap hooks 11. The internal snap hooks axially lock the bearing bush in relation to the bearing journal together with the spring elements 18. The internal snap hooks are engaged with the ring groove at the free end of the bearing journal and, because of the spring action of the spring elements 18, are axially pressed against the outer groove flank of the ring groove of the bearing journal. The bearing bush would be rotatable in relation to the bearing journal, but this rotation can be prevented by corresponding openings in the ring groove.

This bearing bush 1 is produced from a low-friction plastic, which minimizes both the wear upon the opening of the selection lever and also the wear on the bearing journal. For this purpose, the bearing bush 1 can preferably be produced from polytetrafluoroethylene or another low-friction plastic. The bearing bush 1 having the compensation element 6 can be produced in one piece in an injection-molding method, which reduces the production costs of a bearing bush of this type which axially locks the selection lever on the bearing journal. The installation costs are simultaneously reduced in that the three components of selection lever, bearing bush, and bearing journal can be plugged axially on one another in a self-locking manner.

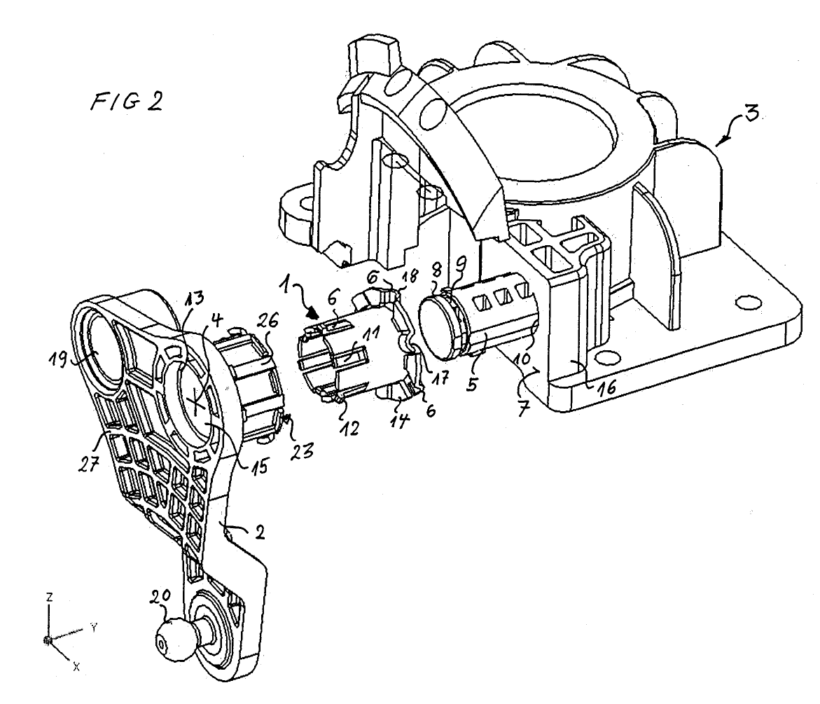

FIG. 2 shows a schematic perspective exploded view of a shift housing 3 having the bearing bush 1 according to FIG. 1 for mounting a selection lever 2 on a bearing journal 5 of the shift housing 3. The selection lever 2 transmits selection movements of a selection finger of a gear shift lever (not shown) to traction and/or compression movements of a selection cable pull (not shown), the selection finger being received by the receptacle hole 19 of the selection lever 2 and the selection cable pull being attached to an attachment journal 20 in the form of a ball stud. This ball stud can also be implemented as a cylindrical attachment journal 20 for the selection cable pull.

The selection lever 2 is pivotable around a pivot point 4 on the bearing journal 5 for the transmission of the deflection of the selection finger to the selection cable pull. For mounting on the bearing journal 5, the selection lever 2 has a tubular extension 23 of a bearing hole 15, the tubular extension 23 having reinforcement ribs 26 in the axial direction. In addition, the bearing hole 15 has an indentation 13 of a greater diameter than the bearing hole 15. This indentation 13 is used for axially fixing the selection lever 2 on the bearing journal 5 of the shift housing 3 with the aid of the bearing bush 1. The structure of the selection lever 2 has reinforcement ribs 27, in order to reinforce highly loaded areas of the selection lever 2.

The bearing journal 5 of the shift housing 3 is also cast on with the shift housing 3 in an injection-molding process and has a cast-on end 10 on an axial contact surface 7 of the shift housing 3. A free end 8 of the bearing journal 5 has a ring groove 9, which is used for axially fixing the selection lever 2, which is pivotable on the bearing journal 5. Because both the shift housing 3 and also the selection lever 2 are injection molded from a fiber-reinforced plastic, the bearing bush 1, which is made of a plastic improving the friction mounting, such as polytetrafluoroethylene, is provided between the bearing journal 5 and the tubular extension 23 of the bearing hole 15, so that two fiber-reinforced plastic parts are prevented from rubbing on one another. In order to connect the cast-on bearing journal 5 to the shift housing 3 in a mechanically stable manner, the shift housing 3 has a reinforcement element 16 for the axial contact surface 7 in the area of the cast-on bearing journal 5.

For the axial fixing of the selection lever 2 on the bearing journal 5, the bearing bush 1 described in greater detail above has locking and spring elements, in order to ensure that, without additional clip rings or other aids for axially securing the selection lever 2 with the bearing bush 1 axially on the bearing journal 5 upon assembly, the three components are automatically axially locked. The external snap hooks 12 and internal snap hooks 11 of the bearing bush are used for this purpose, the external snap hooks 12 being able to be engaged with the indentation 13 of the bearing hole 15 and the internal snap hooks 11 being able to engage in the ring groove 9 of the bearing journal 5. A flange-like shoulder 14 of the bearing bush 1 additionally has spring elements 17 and 18, which axially lock the internal snap hooks 11 and the external snap hooks 12 in the ring groove 9 or on the indentation 13, respectively, in a spring-loaded manner. It is ensured that the selection lever 2 remains axially locked on the bearing journal 5 by simply clicking together the snap hooks 11 and 12.

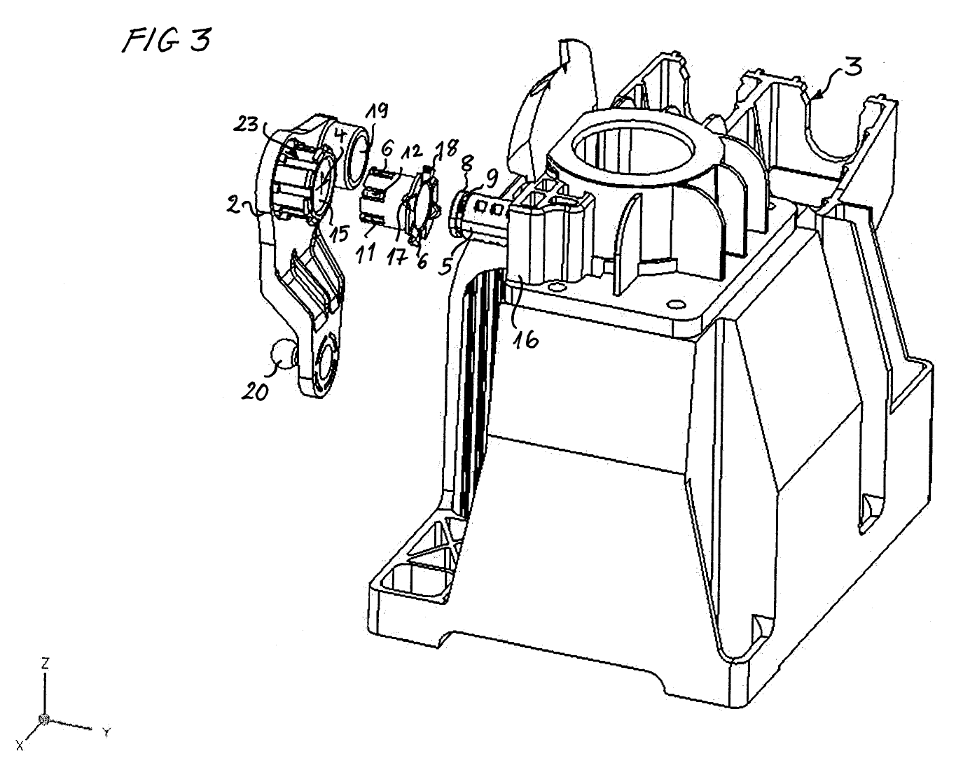

FIG. 3 shows a schematic perspective view of a bearing bush 1 of a shift housing 3 according to FIG. 2 from a different perspective. Components having identical functions as in FIG. 2 are identified by identical reference numerals and are not explained further.

While the receptacle hole 19 receives a selection finger of the gear shift lever of the vehicle, the bearing hole 15 of the selection lever 2 is used to implement a pivot point 4 for the selection lever 2 on the cast-on bearing journal 5 of the shift housing 3. The axial length of the tubular extension 23 of the bearing hole 5 corresponds to the axial length of the receptacle hole 19 for the selection finger of the gear shift lever of the vehicle.

For the assembly or installation of the selection lever 2 on the bearing journal 5, firstly the bearing bush 1 is inserted into the bearing hole 15 of the selection lever 2 until the external snap hooks of the bearing bush 1 catch in the indentation 13 of the bearing hole 15. The selection lever 2 having the bearing bush 1 is then pushed onto the bearing journal 5 until the internal snap hooks 11 engage in the ring groove 9 of the bearing journal 5.

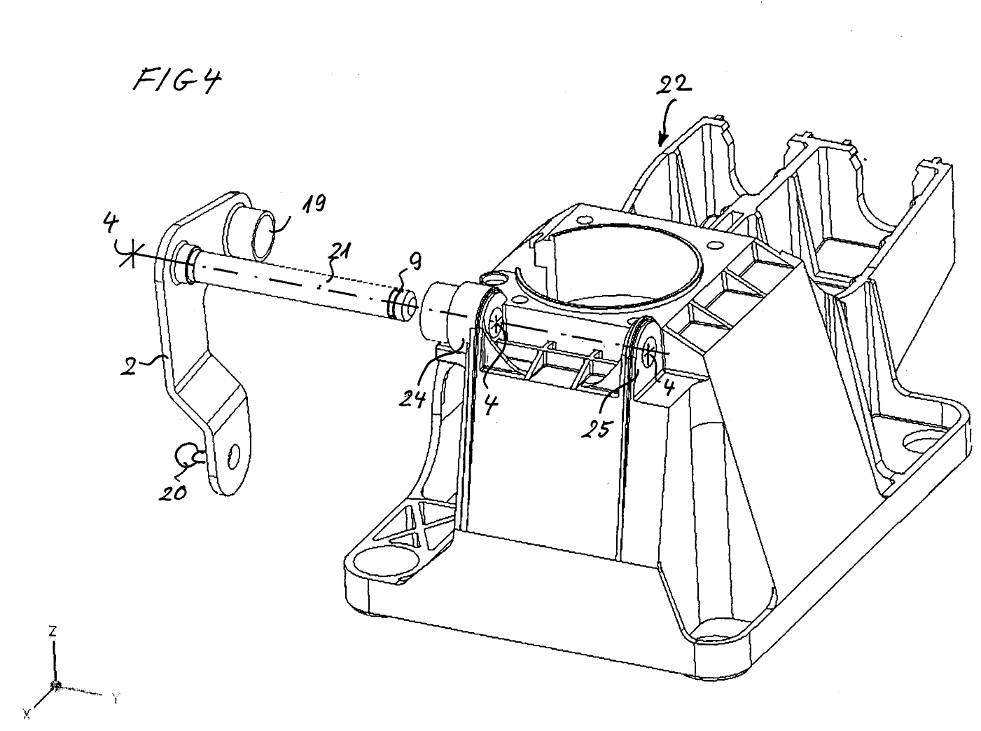

FIG. 4 shows a schematic perspective view of a shift housing 22 having a selection lever 2 and a selection shaft 21 according to the prior art, as already explained at the beginning, so that a further description of FIG. 4 will be dispensed with.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A bearing bush for a shift housing of a vehicle for mounting a selection lever that transmits a selection movement of a selection finger of a gear shift lever to movements of a selection cable pull and pivots around a pivot point into a plurality of selection positions,
the bearing bush used to mount the selection lever to provide a rotatable arrangement on a cast-on bearing journal of the shift housing;
a radial compensation element of the bearing bush; and
an axial compensation element of the bearing bush is adapted to operate in conjunction with the radial compensation element to axially lock the selection lever on the cast-on bearing journal during a pivot movement.

2. The bearing bush according to claim 1, wherein the cast-on bearing journal is fixed using a cast-on end on an axial contact surface of the shift housing and comprises a ring groove on a free end in which the radial compensation element and the axial compensation element in a form of an internal snap hook of the bearing bush engage.

3. The bearing bush according to claim 1, wherein the selection lever comprises a bearing hole in the pivot point for the pivotable mounting on the cast-on bearing journal, the bearing hole comprising an indentation of a greater diameter than the bearing hole, and the radial compensation element and the axial compensation element in a form of an external snap hook of the bearing bush being engaged with the indentation.

4. The bearing bush according to claim 3, wherein the bearing bush comprising a flange-like shoulder supported on an axial contact surface of the shift housing and comprises the axial compensation element in the form of a spring element that axially lock a shoulder in relation to the external snap hook on the indentation of the bearing hole of the selection lever.

5. The bearing bush according to claim 2, wherein the bearing bush comprises a shoulder supported on the axial contact surface of the shift housing and comprises the axial compensation element in the form of a spring element that axially lock the shoulder in relation to the internal snap hook in the ring groove of the cast-on bearing journal.

6. The bearing bush according to claim 1, wherein the cast-on bearing journal and the selection lever comprise fiber-reinforced polyamide and the bearing bush comprises polytetrafluoroethylene.

7. The bearing bush according to claim 1, wherein the cast-on bearing journal is cast onto the shift housing is connected to the shift housing via a reinforcement element.

8. The bearing bush according to claim 1, wherein a spring element is supported on the shift housing that holds the selection lever and with the selection finger, the gear shift lever in a neutral selection position.

9. A method for installing a bearing bush in a shift housing, comprising the steps of:
producing the shift housing comprising a cast-on bearing journal for the pivotable mounting of a selection lever on the shift housing, the cast-on bearing journal comprising a ring groove for axially securing the selection lever;
producing the bearing bush that can be fitted with a bearing hole of the selection lever;
fitting the bearing bush in the bearing hole of the selection lever with snapping of external snap hooks of the bearing bush in an indentation of the bearing hole of the selection lever; and
plugging the selection lever with the bearing bush onto the cast-on bearing journal of the shift housing with snapping of internal snap hooks into the ring groove of the cast-on bearing journal and with simultaneous receiving of a selection finger of a gear shift lever in a receptacle hole of the selection lever.

10. The method according to claim 9, further comprising the step of holding the selection lever on the cast-on bearing journal in an axially-locked position with a spring element of a flange-like shoulder of the bearing bush.

11. The method according to claim 9, further comprising the step of connecting a selection cable pull to an attachment journal of the selection lever.

12. The method according to claim 9, further comprising the step of reinforcing the shift housing in an area of the cast-on bearing journal.
